(19) United States
(12) Patent Application Publication
(10) Pub. No.: US 2015/0271263 A1
(43) Pub. Date: Sep. 24, 2015

(54) COLLECTING APPLICATION SHARING INFORMATION

(71) Applicant: Nokia Corporation, Espoo (FI)

(72) Inventors: Dong Liu, Beijing (CN); Xiantao Chen, Beijing (CN)

(21) Appl. No.: 14/413,055

(22) PCT Filed: Jul. 30, 2013
(86) PCT No.: PCT/IB2013/056240

§ 371 Date: Jan. 6, 2015

(30) Foreign Application Priority Data
Jul. 31, 2012 (CN) 201210279450.X

(51) Int. Cl. H04L 29/08; G06F 9/54; G06F 17/30

(52) U.S. Cl. CPC H04L 67/1095; G06F 17/30867; G06F 9/541

(57) ABSTRACT

Embodiments of the present invention provide a method and apparatus for collecting users' application sharing information. The method comprises: receiving a request from a first user for sharing a first application; generating information regarding the first user sharing the first application; transmitting the information regarding the first user sharing the first application; receiving a result of sharing of the first application, such that the first application shared by the first user may provide an extra function to the first user according to the result of sharing of the first application. According to the present invention, relevant information regarding sharing an application through an SNS website, a forum or even between mobile terminals can be collected, such that the shared application may provide an extra function to the sharer based on the result of sharing of the application.

### FIELD OF THE INVENTION

Embodiments of the present invention relate to the field of information processing, and more specifically, relate to collecting user's application sharing information.

### BACKGROUND OF THE INVENTION

At present, with the rapid development of intelligent mobile terminals, applications that may be installed on the intelligent mobile terminals are growing rapidly. An application refers to a program design language for implementing a certain function and a set of programs programmed with the program design language. By usage of applications, applications may be categorized into entertainment type, game type, book type, life type, tool type, and social networking type, and so on. The focus of the developers of these applications and/or the application store servers is how to let users know these applications.

“Word of mouth” propagation is a good way to let users know these applications. The so-called “word of mouth” propagation means the communication and sharing performed among users. With the population of Internet, a user may share an application which he/she deems nice to his/her friends or other users through a server providing a social network service SNS or forum function.

Social network service provides a new approach for communicating and sharing information. A website that provides the social network service would generally have millions of subscribers. It has become a part of users' daily life to use this service. Currently, there are many websites that provide social network services around the world, among which well-known ones are Facebook, Quazza.com, Myspace, Orkut, Twitter, and the like. In China, well-known websites that provide social network services include renren.com, kaixin001.com, weibo.com, etc.

However, there is not provided a solution yet, that can collect relevant information regarding sharing applications through SNS websites, forums, or even between mobile terminals.

### SUMMARY OF THE INVENTION

According to a first aspect of the present invention, there is provided a method, comprising: receiving a request from a first user for sharing a first application; generating information regarding the first user sharing the first application; transmitting the information regarding the first user sharing the first application; receiving a result of sharing of the first application, such that the first application shared by the first user may provide an extra function to the first user according to the result of sharing of the first application.

According to a second aspect, there is provided a method, comprising: directing a second user who, after seeing application sharing information, was interested in the shared first application to a second server where the shared first application may be downloaded; and recording information that the second user was interested in the shared first application and thus visited the second server where the shared first application may be purchased and downloaded.

According to a third aspect of the present invention, there is provided an apparatus, comprising: a first receiving unit configured to receive a request from a first user for sharing a first application; a generating unit configured to generate information regarding the first user sharing the first application; a first transmitting unit configured to transmit information regarding the first user sharing the first application; a second receiving unit configured to receive a result of sharing of the first application, such that the first application shared by the first user may provide an extra function to the first user according to the result of sharing of the first application.

According to a fourth aspect, there is provided an apparatus, comprising: a re-directing unit configured to direct a second user who, after seeing application sharing information, was interested in the shared first application to a second server where the shared first application may be downloaded; and a first recording unit configured to record information that the second user was interested in the shared first application and thus visited the second server where the shared first application may be purchased and downloaded.

According to a fifth aspect of the present invention, there is provided an apparatus, comprising: at least one processor and at least one memory containing computer program code; the processor and the memory are configured to, utilizing the processor, enable the apparatus to perform at least the following: receiving a request from a first user for sharing a first application; generating information regarding the first user sharing the first application; transmitting the information regarding the first user sharing the first application; receiving a result of sharing of the first application, such that the first application shared by the first user may provide an extra function to the first user according to the result of sharing of the first application.

According to a sixth aspect of the present invention, there is provided an apparatus, comprising: at least one processor and at least one memory containing computer program code; the processor and the memory are configured to, utilizing the processor, enable the apparatus to perform at least the following: directing a second user who, after seeing application sharing information, was interested in the shared first application to a second server where the shared first application may be downloaded; and recording information that the second user was interested in the shared first application and thus visited the second server where the shared first application may be purchased and downloaded.

According to the present invention, relevant information regarding sharing an application through an SNS website, a forum or even between mobile terminals can be collected, such that the shared application may provide an extra function to the sharer based on the result of sharing of the application.

### BRIEF DESCRIPTION OF THE SEVERAL VIEWS OF THE DRAWINGS

Other objectives and effects of the present invention will become much clearer and easier to understand through the following description with reference to the accompanying drawings and with more comprehensible understanding of the present invention, wherein:

FIG. 1 shows a block diagram of a mobile terminal 10 which is applicable to implement the embodiments of the present invention;

FIG. 2 schematically shows a wireless communication system according to an embodiment of the present invention;

FIG. 3 shows a communication flow between a user, an application installed on the user's mobile terminal 10 and an application sharing client, an application sharing server, a first server, and a second server according to one embodiment of the present invention;

FIG. 4 shows an example of a user interface of the application sharing client;

FIG. 5 shows an example of a dialog box appearing after the user clicks onto a “Share” button corresponding to an application in the application sharing client;

FIG. 6 shows a Share Result Table as recorded by the application sharing server according to one embodiment of the present invention;

FIG. 7 shows a block diagram of the application sharing client according to one embodiment of the present invention;

FIG. 8 shows a block diagram of the application sharing server according to one embodiment of the present invention;

FIG. 9 shows a block diagram of the application sharing client according to another embodiment of the present invention;

FIG. 10 shows a block diagram of the application sharing server according to a further embodiment of the present invention;

In all of the above accompanying drawings, like reference numbers indicate same, like or corresponding features or functions.

### DETAILED DESCRIPTION OF THE INVENTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

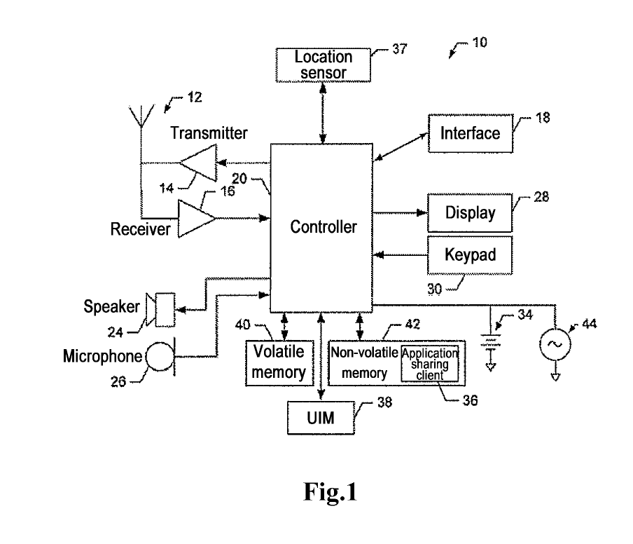

FIG. 1 shows a block diagram of a mobile terminal 10 which is applicable to implement the embodiments of the present invention. However, it should be understood that the mobile terminal as illustrated and depicted hereinafter is merely an example mobile terminal suitable for implementing the embodiments of the present invention. Thus, it should not be used to limit the scope of the embodiments of the present invention.

The mobile terminal, for example, is a mobile phone, a personal digital assistant (PDA), a pad, a mobile TV, a gaming device, a laptop, a camera, a video camera, a GPS device, and the like.

Besides, it should be understood that a non-mobile terminal is also suitable for implementing the embodiments of the present invention.

Hereinafter, the embodiments of the present invention will be depicted mainly with reference to the radio communication application. However, it should be understood that the present invention is also applicable for the wired communication circumstance.

The mobile terminal 10 comprises an antenna 12 which may communicate with a transmitter 14 and a receiver 16. The mobile terminal 10 further comprises a controller 20, which provides a signal to the transmitter 14 and receives a signal from the receiver 16, respectively. The signal includes signaling information according to an appropriate air-interface criterion and further includes text, speech and/or video. The mobile terminal 10 may operate using one or more air-interface criteria. As an illustration, the mobile terminal 10 may operate based on any protocol among the first, second, third, and/or fourth generation cellular communication system protocols. For example, the mobile terminal 10 can operate according to the 2nd generation (2G) wireless communication protocol IS-136 (time-division multi-access: TDMA), GSM (Global System for Mobile Communications) or IS-95 (code-division multi-access: CDMA); or according to the third generation (3G) wireless communication protocol such as Universal Mobile Telecommunications System (UMTS), CDMA2000, Wideband CDMA (WCDMA) or Time Division-Synchronous CDMA (TD-SCDMA); or according to the 4th generation (4G) wireless communication protocol. The mobile terminal 10 may further comprise an interface 18 for implementing near-field communication, for example, a radio frequency (RF) interface, a Bluetooth (BT) interface, or an Infrared (IrDa) interface. The controller 20 also provides a signal destined to the interface 18 and receives a signal from the interface 18. It should be understood that the controller 20 comprises devices, such as circuits, required for performing the functions of the mobile terminal 10. For example, the controller 20 may comprise a digital signal processor, a microprocessor, various kinds of ND converters, D/A converters, and other support circuits. The control and signal processing functions of the mobile terminal 10 are allocated thereamong in accordance with respective capabilities of these devices. The controller 20 may comprise a functionality of performing convolutional coding and interleaving to a message before it is modulated and transmitted. The controller 20 may further comprise an internal voice encoder and may comprise an internal data modem. In addition, the controller 20 may comprise a functionality of operating one or more software programs that may be stored in a memory. For example, the controller 20 may operate a connectivity program, for example, a Web browser. The connectivity program may allow the mobile terminal 10 to transmit and receive Web contents for example according to the wireless application protocol (WAP), the hypertext transmission protocol (HTTP), etc.

The mobile terminal 10 may further comprise an output device and a user input device, both of which are coupled to the controller 20. The output device comprises for example a traditional earphone or speaker 24, display 28, and the like. The user input device comprises a microphone 26, a user input device allowing the mobile terminal 10 to receive data, which user input device may include a keypad 30, a touch display (not shown), and the like. In an embodiment that a keypad 30 is included, the keypad 30 may include traditional number keys (0-9) and relevant keys (#, *), and etc. Alternatively, the keypad 30 may include a traditional QWERTY keypad arrangement. Additionally or alternatively, the mobile terminal 10 may include a user input device such as a joystick.

The mobile terminal 10 further comprises a battery 34, such as a vibration battery pack for supplying power to various circuits needed to operate the mobile terminal 10. The mobile terminal 10 may also be powered by a supplementary power source 44. The supplementary power source 44 may directly supply power to the mobile terminal 10. The supplementary power source 44 may further supply power to the mobile terminal 10 indirectly through charging the battery 34, while the battery 34 directly supplies power to the mobile terminal 10. Therefore, in some embodiments, even if the mobile terminal 10 is connected to the supplementary power source 44, the mobile terminal 10 may not operate until the battery 34 receives sufficient charge from the supplementary power source 44. Besides, the supplementary power source 44 may be removed from the mobile terminal 10 so as to allow free mobility of the mobile terminal 10. When the supplementary power source 44 is removed or disconnected in a physical or electric manner, the battery 34 may be a sole power source of the mobile terminal 10.

The controller 20 of the mobile terminal 10 may comprise a functionality and/or circuit for detecting the battery level of the battery 34. The battery level may be any indication of the remaining power or remaining time for the battery 34. When considering whether to perform various operations, the controller 20 may user the battery level. The controller 20 may also detect whether the mobile terminal 10 is connected to the supplementary power source 44. The controller 20 may directly detect connection to the supplementary power source via for example an input to the controller 20.

The mobile terminal 10 may further include an application sharing client 36. The application sharing client 36 may be any apparatus, device or circuit that is implemented by hardware, software, or a combination of hardware and software, which may manage, on the mobile terminal 10, the sharing of applications on the mobile terminal 10.

In the embodiments depicted hereinafter, it is assumed that the application sharing client 36 is a software application stored in a memory and executed by the controller 20 of the mobile terminal 10. Hereinafter, the application sharing client 36 will be further depicted.

The mobile terminal 10 may further comprise a location sensor 37. The location sensor 37 may be an apparatus, device or circuit in any form for positioning the location of the mobile terminal 10, for example, may be a Global Positioning System (GPS) module communicating with the controller 20.

The location sensor 37 may determine the position of the mobile terminal 10, for example, the longitude, latitude, and altitude of the mobile terminal 10. The information from the location sensor 37 may be transmitted to the memory of the mobile terminal 10 so as to be stored as a positioning history or location information. In addition, the positioning sensor 37 may transmit/receive location information (the location of the mobile terminal 10) via the transmitter 14/receiver 16 utilizing the controller 20.

The mobile terminal 10 may further comprise a user identity module (UIM) 38. The UIM 38 is usually a memory device with a built-in processor. The UIM 38 may for example comprise a subscriber identity module (SIM), a universal integrated circuit card (UICC), a universal user identification module (USIM), or a removable user identity module (R-UIM), etc. The UIM 38 generally stores information associated with the mobile subscriber. Besides UIM 38, the mobile device 10 may also be provided with other memory. For example, the mobile device 10 may comprise a volatile memory 40, for example, a volatile random access memory (RAM) in a cache area for temporarily storing data. The mobile terminal 10 may further comprise a non-volatile memory 42 which may be embedded and/or removable. The non-volatile memory 42 may be an Electrically Erasable Programmable Read Only Memory, a flash memory, and the like. According to one embodiment of the present invention, the application sharing client 36 is stored in the non-volatile memory 42.

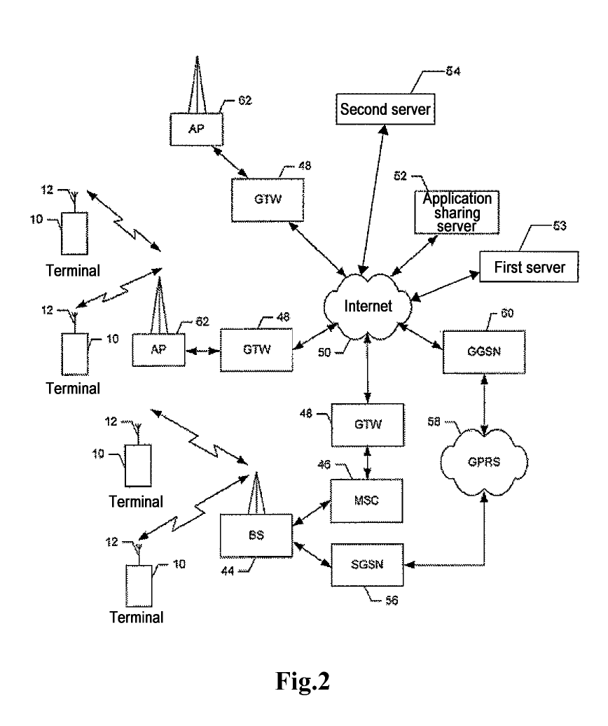

FIG. 2 schematically shows a wireless communication system according to an embodiment of the present invention. Referring to FIG. 2, a kind of wireless communication system suitable for implementing embodiments of the present invention comprises a plurality of devices. As shown in FIG. 2, each mobile terminal 10 comprises an antenna 12 for transmitting signals to a base station (BS) 44 and receiving signals from the base station 44. The base station 44 may be a part of a mobile network, wherein the mobile network comprises devices needed to operate the mobile network, for example, a mobile switching center (MSC) 46. During operation, when the mobile terminal 10 initiates a call or receives a call, the MSC 46 may route the call from or to the mobile terminal 10. It should be noted that although MSC 46 is shown in the wireless communication system in FIG. 2, the MSC 46 is merely an exemplary mobile network device, and the embodiments of the present invention are not limited to the mobile network adopting MSC.

The MSC 46 may be coupled to the data network, for example, a local area network (LAN), a metropolitan area network (MAN), and/or a wide area network (WAN). The MSC 46 may be directly coupled to the data network. However, in a typical embodiment, the MSC 46 is coupled to a gateway device (GTW) 48, while the GTW 48 is coupled to the WAN such as Internet 50. Therefore, the application sharing server 52 may be coupled to the mobile terminal 10 via the Internet 50.

The BS 44 may also be coupled to a signaling GPRS (General Packet Radio Service) support node (SGSN) 56. As known to those skilled in the art, the SGSN 56 can generally perform the function similar to MSC 46 for packet switching services. Similar to MSC 46, the SGSN 56 may be coupled to a data network such as Internet 50. The SGSN 56 may be directly coupled to the data network. However, in a more typical embodiment, the SGSN 56 may be coupled to the packet switching core network, for example, a GPRS core network 58. The packet switching core network is coupled to another GTW, such as a GTW GPRS support node (GGSN) 60, while the GGSN 60 is coupled to the Internet 50.

Through coupling the SGSN 56 to the GPRS core network 58 and the GGSN 60, the application sharing server 52 may be coupled to the mobile terminal 10 via the Internet 50, GGSN 60, GPRS 58, SGSN 56, and the base station 44. Thus, the application sharing server 52 may communicate with the mobile terminal 10. Through directly or indirectly connecting the mobile terminal 10 and the application sharing server 52 to the Internet 50, the mobile terminal 10 may, for example, communicate with the application sharing server 52 according to the hypertext transmission protocol (HTTP) and/or other protocol.

Although not all possible mobile network devices are illustrated and depicted here, it should be noted that the mobile terminal 10 may be coupled to these devices of the mobile network through BS 44. The mobile network can support communication according to one or more protocols of the first generation (1G), second generation (2G), 2.5G, third generation (3G), 3.9G, and fourth generation cellular wireless communication protocols. For example, the mobile network can support communication according to the 2G wireless communication protocol IS-136 (TDMA), GSM or IS-95 (CDMA), etc. For another example, the mobile network can support communication according to the 2.5G wireless communication protocol GPRS or enhanced data GSM environment (EDGE) and the like. For a further example, the mobile network can support communication according to the 3G wireless communication protocol UMTS, and the like.

The mobile terminal 10 may also be coupled to one or more wireless access points (AP) 62. The AP 62 may comprise an access point that communicates with the mobile terminal 10 according to any technology of various wireless network interconnecting technologies, wherein the wireless network interconnecting technologies include: wireless LAN (WLAN) technology such as IEEE 802.11 (for example, 802.11a, 802.11b, 802.11g, 801.11n, etc.) (also known as Wi-Fi), Worldwide Interoperability for Microwave Access (WiMAX) technology such as IEEE 802.16, and Ultra Wideband (UWB) technology such as IEEE 802.15. The AP 62 may be coupled to the Internet 50. Similar to MSC 46, AP 62 may be directly coupled to the Internet 50. However, in one embodiment, the AP 62 is indirectly coupled to the Internet 50 via the GTW 48. Besides, in one embodiment, the BS 44 may be regarded as another AP 62. It would be appreciated that by directly or indirectly connecting the mobile terminals 10 and other devices to the Internet 50, the mobile terminals 10 may communicate with each other or communicate with other devices, to thereby perform various functions of the mobile terminals 10, for example, transmitting data to the application sharing server 52 or receiving data from the application sharing server 52. The terms “data,” “content,” and “information” may be swapped in use to indicate data that is transmitted, received and/or stored according to the embodiments of the present invention. Therefore, use of any of such terms should not be regarded as a limitation to the spirit and scope of the embodiments of the present invention.

Besides coupling the mobile terminals 10 to the application sharing server 52 across the Internet 50, direct coupling and communication between the mobile terminals 10 may be performed according to near-field communication technologies such as RF, BT, IrDA or any technology of other wired or wireless communication technologies.

Additionally, the Internet 50 is also connected with for example a first server 53 that provides a social network service SNS, and for example a second server 54 that provides applications available to the users to purchase and download. Thus, the application sharing server 52 may communicate with the first server 53 and the second server 54.

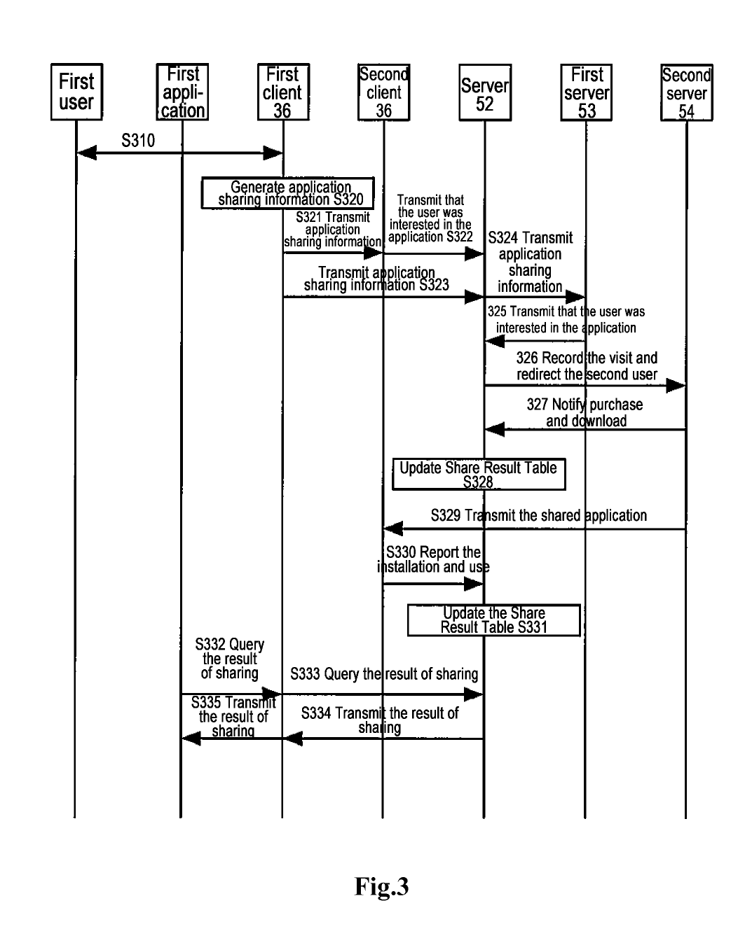

FIG. 3 shows a communication flow between a user, an application installed on the user's mobile terminal 10, the application sharing client 36, the application sharing server 52, the first server 53, and the second server 54 according to one embodiment of the present invention.

Before depicting the specific communication flow, it is assumed that only one same application may be installed on the same mobile terminal, while applications of the same user may be installed on different mobile terminals. The same user installing the same application on different mobile terminals do not belong to the sharing as depicted in the present invention. In other words, the application is bound to the user.

First, when a user of the first mobile terminal 10, which is called here a first user, deems that a first application among a plurality of applications installed on the first mobile terminal 10, for example, the game application Angry Birds, is nice, he/she may share the first application through the application sharing client 36. In this embodiment, the first application may be either known by the first user per se, and purchased and downloaded from the second server 54 and installed on the first mobile terminal 10, or shared to the first user via another user, such that the first user purchased and downloaded from the second server 54 and installed it on the first mobile terminal 10.

The application sharing client 36 of the first mobile terminal 10 manages all applications installed on the first mobile terminal 10, for example, managing their sharing, monitoring their use, and providing the result of sharing to them, such that these applications may provide extra functions to the first user according to the result of sharing, which will be depicted in detail hereinafter.

More specifically, when the first user wishes to share the first application, he/she may click, by finger, onto a “Share” button corresponding to the first application on a user interface of the application sharing client 36 of the first mobile terminal 10.

If an application has been shared, then the “Share” button corresponding to the application may become gray, i.e., no response is generated when clicking onto the “Share” button by finger.

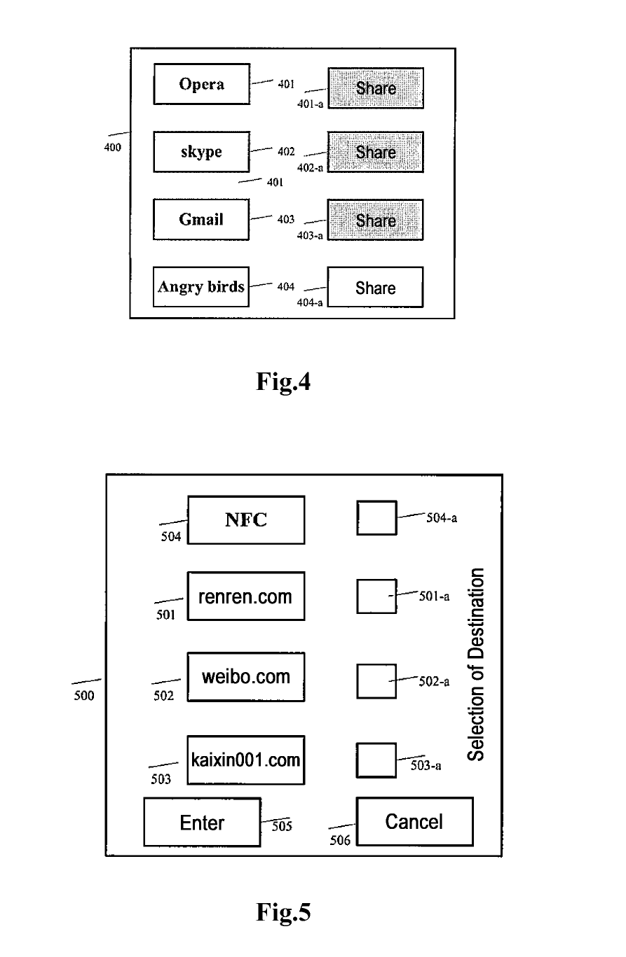

FIG. 4 shows an example of the user interface 400 of the application sharing client 36.

As shown in FIG. 4, the first user has shared applications Opera 401, Skype 402, Gmail 403 with other users, and the “Share” buttons 401-a, 402-a, 403-a corresponding to these applications have become gray. However, the application Angry Birds 404 has not been shared with other users yet, and its corresponding “Share” button has not become gray.

These applications shown in FIG. 4 may be shared from other users or known, purchased and downloaded by the first user per se.

When the first user clicks onto the “Share” button corresponding to the application Angry Birds, the dialog box as shown in FIG. 5 pops out. The dialog box displays to the first user a destination to which the first application sharing information may be sent, such that other users may see the application sharing information.

In the dialog box 500 as shown in FIG. 5, the destination exemplarily includes renren.com 501, weibo.com 502, kaixin001.com 503, and NFC 504 (near-field communication, i.e., directly transmitting between two mobile terminals 10, instead of transmitting through a communication network).

In one embodiment of the present invention, the first user can only select one destination for the application sharing information each time, for example, by clicking onto a selection box to the right of the corresponding destination (one of 501-a, 502-a, 503-a, 504-a, wherein clicking onto 501-a corresponds to selection of renren.com, clicking onto 502-a corresponds to selection of weibo.com, clicking onto 503-a corresponds to selection of kaixin001.com, and clicking onto 504-a corresponds to selection of NFC). However, those skilled in the art should understand, in other embodiments of the present invention, the first user may select a plurality of destinations for the application sharing information each time, for example, by clicking onto multiple selection boxes (multiple of 501-a, 502-a, 503-a, 504-a) to the right of the multiple corresponding destinations. The first user may determine his/her selection of the destination(s) for the application sharing information by clicking onto the “Enter” button. Besides, the first user may cancel his/her selection of the destination(s) for the application sharing information by clicking onto the “Cancel” button 506, such that he/she may re-select the destination(s) for the application sharing information.

After the first user selects the destination(s) for the corresponding application sharing information (as above mentioned, the interaction process between the first user and the application sharing client 36 of the first mobile terminal 10 is represented by step S310), the application sharing client 36 of the first mobile terminal 10 (which is also called the first application sharing client 36) generates corresponding information regarding the first user sharing the first application (step S320).

The information at least comprises the identifier of the first user, the identifier or name of the shared first application. The identifier of the first user may be an identifier used by the first user when purchasing and downloading the first application from the second server 54.

When the destination of the application sharing information is NFC, the application sharing client 36 on the first mobile terminal 10 directly sends the information regarding the first user sharing the first application to the application sharing client 36 of other mobile terminals 10 (here, for the sake of brevity, only one other mobile terminal is shown, i.e., the second mobile terminal 10) (step S321).

The application sharing client 36 on the second mobile terminal 10, after receiving the information regarding the first user sharing the first application as sent from the application sharing client 36 on the first mobile terminal 10, if the second user was interested in the shared first application and clicked onto a corresponding button or link, may generate information that a second user having the second mobile terminal 10 was interested in the first application as shared by the first user. The information at least comprises the identifier of the first user, the identifier or name of the shared first application, and the identifier of the second user, wherein the identifier of the second user may be for example the identifier adopted by the second user when purchasing and downloading applications from the second server 54 or the identifier of the second mobile terminal 10. The information may be sent to the application sharing server 52 (step S322) through a communication network or in other manner. However, in other embodiments of the present invention, it is also possible that the application sharing client 36 on the first mobile terminal 10, after obtaining the identifier of the second user having the second mobile terminal 10, generates information that the second user was interested in the first application as shared by the first user, and sends the information to the application sharing server 52 through a data network or in other manner.

When the destination of the application sharing information is a non-NFC social website, the application sharing client 36 on the first mobile terminal 10 sends to the application sharing server 52 the information regarding the first user sharing the first application (step S323).

In this case, when there are multiple application sharing information destinations, the information at least comprises the identifier of the first user, the identifier or name of the shared first application, and the application sharing information destinations.

After receiving the application sharing information at step S323, the application sharing server 52 sends the corresponding application sharing information to a destination social website (first server 53) such that other users may see the application sharing information on the destination social website (step S324).

According to one embodiment of the present invention, the first user is a registered user of the destination social website. The application sharing server 52, in the name of the first user, publishes the application sharing information on the destination social website, such that the friends of the first user may see the application sharing information on the destination social website.

The application sharing information published on the destination social website may include corresponding literal depiction and the corresponding link, for example, “I think this application is nice, please download it at http://appshare.nokia.com/appName=AngryBird&fromUser=a”.

Where http://appshare.nokia.com/ is the URI of the application sharing server 52, following the appName is the name of the shared first application, and following fromUser is the identifier of the first user initiating the sharing of the first application.

When a second user as a friend of the first user sees the sharing information on the social website on the second mobile terminal 10, he may click onto the link included in the application sharing information. In one embodiment of the present invention, the clicking operation will be recorded by the social website, such that the social website sends the information that the second user was interested in the shared first application to the application sharing server 52 (step S325). The information at least includes the identifier of the first user, the identifier or name of the shared first application, and the identifier of the second user, wherein in this case the identifier of the second user may be the username of the second user on the social website. However, in other embodiments of the present invention, it is also possible that the second user, after clicking onto the link, visits the application sharing server 52 and uses his/her own username and/or password to log onto the application sharing server 52. Therefore, the application sharing server 52 may record the information that the second user was interested in the first application as shared by the first user.

The application sharing server 52, after receiving the information that the second user was interested in the shared first application at step S325 or step S322, records the result of sharing therein and re-directs the second user to the second server 54 from which the shared first application may be downloaded (step S326). For example, the second server may be an application store from which the second user may purchase and download the shared first application.

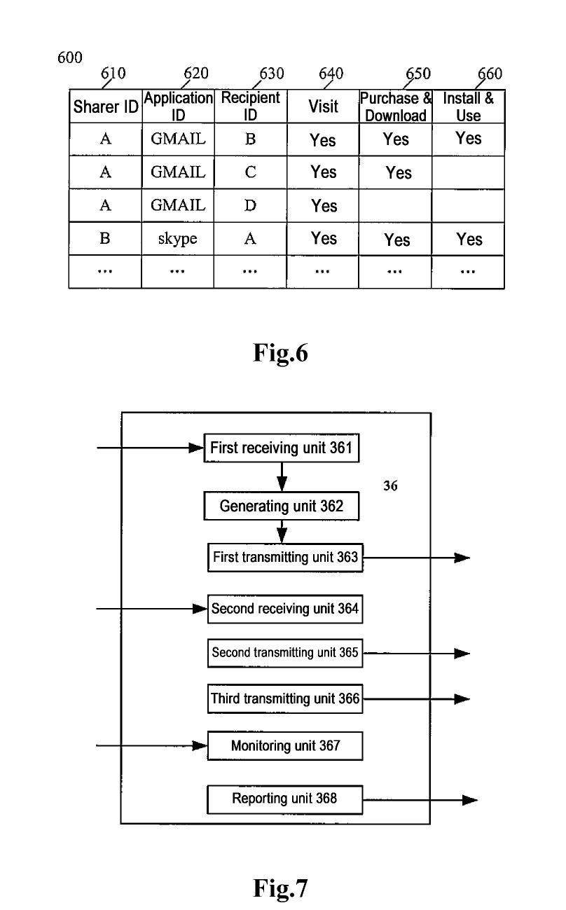

FIG. 6 shows a Share Result Table 600 as recorded by the application sharing server 52 according to one embodiment of the present invention.

The first column 610 of the Share Result Table 600 records the identifiers of the sharers; the second column 620 records the names or identifiers of the shared applications; the third column 630 records the identifiers of the sharing recipients; the fourth-sixth columns record the sharing actions, respectively, where the fourth column records that the sharing recipients were interested in the shared applications and therefore visited the second server from which the shared applications may be downloaded; the fifth column 650 records that the sharing recipients purchased and downloaded the shared applications from the second server; and the sixth column 660 records that the sharing recipient installed and used the shared applications on their mobile terminals.

Besides, the Share Result Table may also include time information of respective corresponding sharing actions (visit, purchase and download, install and use), etc.

At step S326, the application sharing server 52 may record the following information in the Share Result Table 600: identifier of the sharer, name or identifier of the shared application, identifier of the sharing recipient, and setting the Visit action to true.

When the second user purchased and downloaded the shared first application from the second server 54, the second server 54 notifies the application sharing server 52 of the purchasing and downloading of the shared first application (step S327).

After receiving the second user's purchasing and downloading of the shared first application from the second server 54, the application sharing server 52 updates the Share Result Table 600 and sets the corresponding action of Purchase and Download in the Share Result Table 600 to true (step S328).

Meanwhile, the shared first application is transmitted from the second server to the second mobile terminal 10 (step S329).

The application sharing client 36 on the second mobile terminal 10 may monitor the installation and use of the shared first application (or the shared first application may report its installation and use to the application sharing client 36 on the second mobile terminal 10), and report the installation and use information of the shared first application to the application sharing server 52 (step S330).

After receiving the installation and use information regarding the shared first application, the application sharing server 52 updates the Share Result Table 600 and sets the corresponding action Install and Use in the Share Result Table 600 to true (step S331).

When friends of the first user or a nearby third user, fourth user, fifth user, . . . , see the application sharing information on the social website on their corresponding mobile terminals 10, or on corresponding mobile terminals 10, if they are interested in the shared first application, then the above depicted various steps may also be performed between the corresponding devices. For the sake of brevity, detailed depiction of these steps is omitted here.

By far, the application sharing server 52 has completely recorded the result of sharing regarding the first application as shared by the first user.

Those skilled in the art would appreciate that based on the steps between corresponding devices as depicted above, the result of sharing regarding other applications shared by the first user may be recorded, and the result of sharing regarding the first application or other applications shared by other users may also be recorded.

Of course, those skilled in the art would appreciate that for example, if the mobile terminals have the capabilities of mutual connection and data transmission therebetween, the present invention may also be surely implemented without an application sharing server.

Additionally, the identifier of the sharing recipient for purchasing and downloading the application from the second server might not be identical to the identifier of the sharing recipient as registered in the destination social website. In this case, the two identifiers of the sharing recipient are simultaneously recorded in the Share Result Table 600. In one embodiment of the present invention, a correspondence relationship between the two identifiers can be established through the user providing the two identifiers and/or corresponding passwords.

Hereinafter, it will be depicted how to utilize the result of the sharing regarding the application shared by a user as recorded by the application sharing server 52.

The first application, as shared by the first user, on the first mobile terminal 10 knows that it is likely to be shared by the first user. Thus, it may sends a request for querying the result of sharing to the application sharing client on the first mobile terminal 10 at a certain interval (step S332). The request at least includes the identifier and/or name of the first application and the specific content for query.

The query request may be conducted through an API (application programming interface). Such APIs may be provided by the developer of the application sharing client to the developer of the application.

For example, an API similar to SQL (structural query language) may be provided:

SELECT share.toUser FROM share, buy, play WHERE share.fromUser=this AND share.toUser=buy.user AND share.appName=AngryBird AND buy.user=play.user AND buy.appName=AngryBird AND play.appName=AngryBird AND play.hasPlayed=true AND share.timestamp<buy.timestamp AND buy.timestamp<play.timestamp;

share (fromUser, toUser, appName, timestamp)://recording the Share action

buy (user, appName, timestamp)://recording the Purchase action

play (user, appName, hasPlayed, timestamp)://Recording the Use action

In the above example, the AngryBird is the name of the application provided by the first application when initiating a Share Result Query request through the API. this means the first application is to query the result of the sharing by the first user having the mobile terminal (because the first application might not know the identifier of the first user of the mobile terminal 10).

Such API similar to SQL might be too open, because it can provide far more information than the required, such that it overly exposes user information.

In order to avoid overly exposing user information, the developer of the application sharing client may also provide a function-type API available for an application developer, for example, the following API may be provided:

boolean hasSharedToSomePeople(Number n).

In this case, the application may invoke the function with the parameter n=10, so as to query whether the application is shared to 10 other users by the user having this mobile terminal.

In one embodiment of the present invention, the user can control exposition of his/her information so as to protect their privacies. For example, the uses may set his/her information disclosure through a user interface of the application sharing client.

For example, the user may select the following privacy options:

I like/dislike sharing my information about application installation and use and the like;

If other user wants to collect my information about application installation and use and the like, I like/dislike being collected.

If the user sets “I dislike sharing my information about application installation and use and the like” at the user interface of the application sharing client, then the above reporting the installation and use and like information to the application sharing server will not happen.

Return to the discussion of step S332, after receiving the request for querying the result of sharing, the application sharing client 36 on the first mobile terminal 10 sends a request for querying the result of sharing of the application to the application sharing server 52 (step S333), the request at least including the identifier of the first user having the first mobile terminal 10, the identifier or name of the shared application, and the specific content for query. The query for the result of sharing between the application sharing client 36 and the application sharing server 52 may be implemented by various technologies. It is not the focus of the present invention, and thus the detailed depiction thereof is omitted.

After receiving the request for querying the result of sharing from the first mobile terminal 10, the application sharing server 52 returns the corresponding result of sharing to the application sharing client 36 (step S334). Then, the application sharing client 36 sends the received application sharing result to the corresponding application (step S335).

Of course, those skilled in the art would appreciate that the application sharing server 52 may also send the application sharing result of the corresponding application to the application sharing client 36 in advance. In this way, when the application sharing client 36 receives the request for querying application sharing result from the corresponding application, it would not need querying the application sharing server 52.

After the application shared by the first user receives the result of sharing, it may provide extra functions to the first user according to the result of application sharing. For example, if the result of sharing shows that users exceeding a predetermined number have accepted the sharing, purchased and downloaded, installed and used the shared application within a certain period of time, then it provides extra functions to the first user.

The extra functions include one or more of the following:

providing a longer use time of the application to the first user;

providing a more advanced version of the application to the first user;

discounting the charge for the first user in some charged items of the application.

FIG. 7 shows a block diagram of the application sharing client according to one embodiment of the present invention.

As shown in FIG. 7, the application sharing client 36 comprises a first receiving unit 361 configured to receive a request from a first user for sharing a first application; a generating unit 362 configured to generate information regarding the first user sharing the first application; a first transmitting unit 363 configured to transmit the information regarding the first user sharing the first application; a second receiving unit 364 configured to receive a result of sharing of the first application, such that the first application shared by the first user may provide an extra function to the first user according to the result of sharing of the first application.

According to one embodiment of the present invention, the application sharing client 36 further comprises: a second transmitting unit 365 configured to send, in response to a request for querying the result of sharing of the first application, the result of sharing of the first application.

According to one embodiment of the present invention, the application sharing client 36 further comprises: a third transmitting unit 366 configured to transmit, in response to a request for querying the result of sharing of the first application, the request for querying the result of sharing of the first application.

According to one embodiment of the present invention, the request for querying the result of sharing of the first application is implemented through an API.

According to one embodiment of the present invention, the result of sharing of the first application includes: information regarding the number and/or identifiers of users who, after seeing the sharing information, were interested in the shared first application, and thus visited the server from which the shared first application may be purchased and downloaded.

According to one embodiment of the present invention, the result of sharing of the first application further includes: information regarding the number and/or identifiers of users who purchased and downloaded the shared first application.

According to one embodiment of the present invention, the result of sharing of the first application further includes: information regarding the number and/or identifiers of users who installed and used the shared first application.

According to one embodiment of the present invention, the application sharing client 36 further comprises: a monitoring unit 367 configured to monitor the first user's installation and use information of a second application which is shared from another user.

According to one embodiment of the present invention, the application sharing client 36 further comprises: a reporting unit 368 configured to report the monitored first user's installation and use information of the second application which is shared from the another user.

According to one embodiment of the present invention, the information about the first user sharing the first application is sent and the result of sharing of the first application is received via near-field communication.

According to one embodiment of the present invention, the information about the first user sharing the first application is sent and the result of sharing of the first application is received via a communication network.

According to one embodiment of the present invention, the information about the first user sharing the first application at least includes the identifier of the first user and the identifier and/name of the first application.

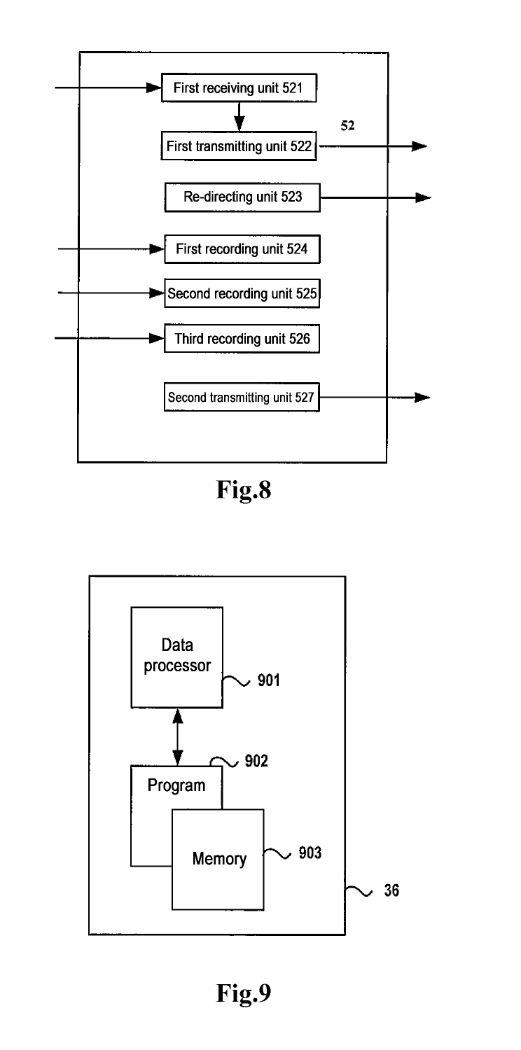

FIG. 8 shows a block diagram of the application sharing server according to one embodiment of the present invention;

As shown in FIG. 8, the application sharing server 52 comprises: a re-directing unit 523 configured to direct a second user who, after seeing the application sharing information, was interested in the shared first application, to a second server from which the shared first application may be downloaded; and a first recording unit 524 configured to record the information that the second user was interested in the shared first application and thus visited the second server from which the shared first application may be purchased and downloaded.

According to one embodiment of the present invention, the application sharing server 52 further comprises: a first receiving unit 521 configured to receive information about the first user sharing the first application; a first transmitting unit 522 configured to transmit corresponding sharing information to an assigned first server such that other users may see the sharing information.

According to one embodiment of the present invention, the application sharing server 52 further includes: a second recording unit 525 configured to record the information as notified from the second server about the second user having purchased and downloaded the shared first application.

According to one embodiment of the present invention, the application sharing server 52 further includes: a third recording unit 526 configured to record the received information about the second user having installed and used the shared first application.

According to one embodiment of the present invention, the application sharing server 52 further comprises: a second transmitting unit 527 configured to transmit the result of sharing of the first application such that the first application shared by the first user may provide an extra function to the first user according to the result of sharing of the first application.

According to one embodiment of the present invention, in response to a request for querying the result of sharing of the first application, the result of sharing of the first application is transmitted.

According to one embodiment of the present invention, the first server provides a social network service.

According to one embodiment of the present invention, the information about the first user sharing the first application at least includes the identifier of the first user and the identifier and/name of the first application.

FIG. 9 shows a block diagram of the application sharing client 36 according to another embodiment of the present invention. As shown in FIG. 9, the application sharing client 36 comprises a data processor (DP) 901 and a memory (MEM) 903 coupled to the data processor 901. The memory 903 stores a program (PROG) 902.

The memory 903 may be of any appropriate type suitable for the local technical environment and may be implemented by any appropriate data storage technologies, for example, may include, but not limited to, a semiconductor-based storage device, a magnetic storage device and system, an optical memory and system. Although FIG. 9 merely shows a memory unit, the application sharing client 36 may have a plurality of different physical memory units. DP 901 may be of any appropriate type suitable for the local technical environment and may include, but not limited to, one or more of a general computer, a dedicated computer, a microprocessor, a digital signal processor (DSP) and processor-based multi-core processor architecture. The application sharing client 36 may comprise a plurality of processors.

As shown in FIG. 9, the data processor 901 and the memory 903 are configured to, utilizing the data processor 901, enable the application sharing client 36 to perform at least the following: receiving a request from a first user for sharing a first application; generating information regarding the first user sharing the first application; transmitting the information regarding the first user sharing the first application; receiving a result of sharing of the first application, such that the first application shared by the first user may provide an extra function to the first user according to the result of sharing of the first application.

According to one embodiment of the present invention, the processor and the memory are further configured to, utilizing the processor, enable the apparatus to perform at least the following: in response to a request for querying the result of sharing of the first application, transmitting the result of sharing of the first application.

According to one embodiment of the present invention, the processor and the memory are further configured to, utilizing the processor, enable the apparatus to perform at least the following: in response to a request for querying the result of sharing of the first application, issuing the request for querying the result of sharing of the first application; and transmitting the received result of sharing of the first application.

According to one embodiment of the present invention, the request for querying the result of sharing of the first application is implemented through an API.

According to one embodiment of the present invention, the result of sharing of the first application includes: information regarding the number and/or identifiers of users who, after seeing the sharing information, were interested in the shared first application, and thus visited the server from which the shared first application may be purchased and downloaded.

According to one embodiment of the present invention, the result of sharing of the first application further includes: information regarding the number and/or identifiers of users who purchased and downloaded the shared first application.

According to one embodiment of the present invention, the result of sharing of the first application further includes: information regarding the number and/or identifiers of users who installed and used the shared first application.

According to one embodiment of the present invention, the processor and the memory are further configured to, utilizing the processor, enable the apparatus to perform at least the following: monitoring the first user's installation and use information of a second application shared from another user.

According to one embodiment of the present invention, the processor and the memory are further configured to, utilizing the processor, enable the apparatus to perform at least the following: reporting the monitored first user's installation and use information of the second application shared from the another user.

According to one embodiment of the present invention, the information about the first user sharing the first application is sent and the result of sharing of the first application is received via near-filed communication.

According to one embodiment of the present invention, the information about the first user sharing the first application is sent and the result of sharing of the first application is received via a communication network.

According to one embodiment of the present invention, the information about the first user sharing the first application at least includes the identifier of the first user and the identifier and/name of the first application.

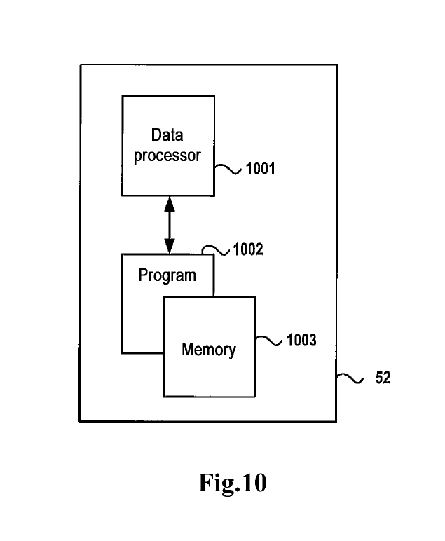

FIG. 10 schematically shows a block diagram of the application sharing server 52 according to another embodiment of the present invention. As shown in FIG. 10, the application sharing server 52 comprises a data processor (DP) 1001 and a memory (MEM) 1003 coupled to the data processor 1001. The memory 1003 stores a program (PROG) 1002.

The memory 1003 may be of any appropriate type suitable for the local technical environment and may be implemented by any appropriate data storage technologies, for example, may include, but not limited to, a semiconductor-based storage device, a magnetic storage device and system, an optical memory and system. Although FIG. 10 merely shows a memory unit, the application sharing server 52 may have a plurality of different physical memory units. DP 1001 may be of any appropriate type suitable for the local technical environment and may include, but not limited to, one or more of a general computer, a dedicated computer, a microprocessor, a digital signal processor (DSP) and processor-based multi-core processor architecture. The application sharing server 52 may comprise a plurality of processors.

As shown in FIG. 10, the data processor 1001 and the memory 1003 are configured to, utilizing the data processor 1001, enable the application sharing server 52 to perform at least the following: directing a second user who, after seeing the application sharing information, was interested in the shared first application, to a second server from which the shared first application may be downloaded; and recording information that the second user was interested in the shared first application and thus visited the second server from which the shared first application may be purchased and downloaded.

According to one embodiment of the present invention, the processor and the memory are further configured to, utilizing the processor, enable the apparatus to perform at least the following: receiving information regarding the first user sharing the first application; transmitting corresponding sharing information to an assigned first server such that other users can see the sharing information.

According to one embodiment of the present invention, the processor and the memory are further configured to, utilizing the processor, enable the apparatus to perform at least the following: recording information notified from the second server about the second user having purchased and downloaded the shared first application.

According to one embodiment of the present invention, the processor and the memory are further configured to, utilizing the processor, enable the apparatus to perform at least the following: recording the received information about the second user having installed and used the shared first application.

According to one embodiment of the present invention, the processor and the memory are further configured to, utilizing the processor, enable the apparatus to perform at least the following: transmitting the result of sharing of the first application such that the first application shared by the first user may provide an extra function to the first user based on the result of sharing of the first application.

According to one embodiment of the present invention, in response to a request for querying the result of sharing of the first application, the result of sharing of the first application is transmitted.

According to one embodiment of the present invention, the first server provides a social network service.

According to one embodiment of the present invention, the information about the first user sharing the first application at least includes the identifier of the first user and the identifier and/name of the first application.

It should be noted that in order to make the present invention more comprehensible, the above description omits some more specific technical details which are known to the skilled in the art and may be essential to implement the present invention.

Thus, selecting and describing the preferred embodiments is to better illustrate the principle and practical application of the present invention and to enable a person of normal skill in the art to appreciate that without departing the spirit of the present invention, all modifications and alterations fall within the protection scope of the present invention as limited by the appending claims.

Further, those skilled in the art may understand, the steps of various methods as above described may be implemented through a programmed computer. Here, some embodiments intend to cover program storage means that is machine-readable or computer-readable and is encoded with machine-executable or computer-executable instruction program, wherein the instruction performs some or all steps of the above methods. The program storage means may be a magnetic storage medium, for example, a disc, a diskette, a hard disk driver, or an optical readable digital data storage medium. The embodiments also intend to cover a computer that is programmed to perform the steps of the methods.

1-62. (canceled)

63. A method, comprising:
receiving a request from a first user for sharing a first application;
generating information regarding the first user sharing the first application;
transmitting the information regarding the first user sharing the first application; and
receiving a result of sharing of the first application such that the first application shared by the first user may provide an extra function to the first user based on the result of sharing of the first application.

64. The method of claim 63, further comprising:
in response to a request for querying the result of sharing of the first application, transmitting the result of sharing of the first application.

65. The method of claim 63, further comprising:
in response to a request for querying the result of sharing of the first application, issuing the request for querying the result of sharing of the first application; and
transmitting the received result of sharing of the first application.

66. The method of claim 63, further comprising:
monitoring the first user's installation and use information of a second application shared from another user.

67. A method, comprising:
directing a second user who, after seeing application sharing information, was interested in a shared first application, to a second server from which the shared first application may be downloaded; and
recording information that the second user was interested in the shared first application and thus visited the second server from which the shared first application may be purchased and downloaded.

68. The method of claim 67, further comprising:
receiving information regarding a first user sharing the first application;
transmitting corresponding sharing information to an assigned first server such that other users can see the sharing information.

69. The method of claim 67, further comprising:
transmitting a result of sharing of the first application such that the first application shared by the first user may provide an extra function to the first user based on the result of sharing of the first application.

70. An apparatus, comprising:
at least one processor and at least one memory containing computer program code;
the processor and the memory being configured to, utilizing the processor, enable the apparatus to perform at least the following:
receive a request from a first user for sharing a first application;
generate information regarding the first user sharing the first application;
transmit the information regarding the first user sharing the first application; and
receive a result of sharing of the first application such that the first application shared by the first user may provide an extra function to the first user based on the result of sharing of the first application.

71. The apparatus of claim 70, wherein the processor and the memory are further configured to, utilizing the processor, in response to a request for querying the result of sharing of the first application, enable the apparatus to perform at least the following:
transmit the result of sharing of the first application;
issue the request for querying the result of sharing of the first application and transmit the received result of sharing of the first application.

72. The apparatus of claim 71, wherein the request for querying the result of sharing of the first application is implemented through an API.

73. The apparatus of claim 70, wherein the result of sharing of the first application includes: information regarding the number and/or identifiers of users who, after seeing the sharing information, were interested in the shared first application, and thus visited the server from which the shared first application may be purchased and downloaded.

74. The apparatus of claim 73, wherein the result of sharing of the first application further includes: information regarding the number and/or identifiers of one of users:
who purchased and downloaded the shared first application;
who installed and used the shared first application.

75. The apparatus of claim 70, wherein the processor and the memory are further configured to, utilizing the processor, enable the apparatus to perform at least the following:
monitor the first user's installation and use information of a second application shared from another user.

76. The apparatus of claim 75, wherein the processor and the memory are further configured to, utilizing the processor, enable the apparatus to perform at least the following:
report the monitored first user's installation and use information of the second application shared from the another user.

77. The apparatus of claim 70, wherein the information about the first user sharing the first application is transmitted and the result of sharing of the first application is received via at least one of near-field communication and
a communication network.

78. The apparatus of claim 70, wherein the information about the first user sharing the first application at least includes an identifier of the first user and an identifier and/name of the first application.

79. An apparatus, comprising:
at least one processor and at least one memory containing computer program code;
the processor and the memory being configured to, utilizing the processor, enable the apparatus to perform at least the following:
direct a second user who, after seeing application sharing information, was interested in a shared first application, to a second server from which the shared first application may be downloaded; and
record information that the second user was interested in the shared first application and thus visited the second server from which the shared first application may be purchased and downloaded.

80. The apparatus of claim 79, wherein the processor and the memory are further configured to, utilizing the processor, enable the apparatus to perform at least the following:
receive information regarding a first user sharing the first application;
transmit corresponding sharing information to an assigned first server such that other users can see the sharing information.

81. The apparatus claim 79, wherein the processor and the memory are further configured to, utilizing the processor, enable the apparatus to perform at least one of the following:
record information notified from the second server regarding the second user having purchased and downloaded the shared first application;
record the received information regarding the second user having installed and used the shared first application.

82. The apparatus of claim 78, wherein the processor and the memory are further configured to, utilizing the processor, enable the apparatus to perform at least the following:
transmit a result of sharing of the first application such that the first application shared by the first user may provide an extra function to the first user based on the result of sharing of the first application.
